(19) United States
(12) Patent Application Publication
(10) Pub. No.: US 2006/0142082 A1
(43) Pub. Date: Jun. 29, 2006

(54) Motion analyzing apparatus and method for a portable device

(76) Inventors: Ming-Tsung Chiang, Sindian City (TW); Chuan-Fu Lin, Sindian City (TW); Kuo-Feng Yen, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/211,669

(22) Filed: Aug. 26, 2005

(30) Foreign Application Priority Data
Dec. 24, 2004 (TW) 093140672

(51) Int. Cl. A63F 13/00

(52) U.S. Cl. 463/36

(57) ABSTRACT

A motion analyzing apparatus and method for a portable device with an output unit is provided. The motion analyzing apparatus comprises a motion database for storing at least one motion pattern or a music database for storing at least one music data, a motion sensor unit for sensing displacement variations of the portable device and outputting corresponding motion signals, and a microprocessor unit for receiving the motion signals, comparing the motion signals with the motion patterns of the motion database, and controlling the output unit according to the comparison result. The motion analyzing apparatus utilizes the portable device to play games and has abundant entertainment and versatile content by working with the body motion of the user.

### BACKGROUND OF THE INVENTION

1. Field of the Invention

The present invention relates to a motion analyzing apparatus and a method for a portable device. In particular, this invention provides a motion analyzing apparatus and method that is applied to a portable device, and the invention utilizes the motion sensor unit in the portable device to sense the body gestures of the user and compares the sensed results with a standard motion database for entertainment.

2. Description of the Related Art

Portable devices, such as portable communication apparatuses, personal digital assistants, hand-held computers, cell phones and laptop computers, are necessary tools for most people in the modern age.

Most of these devices have entertainment programs built into them, so to relieve boredom or stress the user can play a game as a means of distraction. Because of the devices' portability, this allows the user to entertain themselves at any time.

However, the portable devices described above require the user to press the keys thereof, or, in some other way, physically connecting with these devices. Such particular actions represent movements or actions in the hand-held game that is being played.

### SUMMARY OF THE INVENTION

The purpose of the present invention is to provide a motion analyzing apparatus and a method for a portable device. This portable device in the present invention can effectively sense displacement variations in a user's body motions and compare the sensed result with a standard motion database. According to the comparison result, the portable device then outputs the effect by any method that can be implemented in the game thereby making the game more interactive and entertaining for the user. The invention can be applied to any portable device, so users can entertain themselves at any time in anyplace.

The purpose of the motion analyzing apparatus and method for a portable device of the present invention can be combined with other output devices to produce a variety of applications and games, such as an physical exercise, a dancing machine, a conductor, a musical accompaniment, or games of image deformation or rolling a ball into a hole, etc., allowing for abundant and versatile entertainment content.

In order to achieve the above goals, the present invention provides a motion analyzing apparatus for a portable device with an output unit. The motion analyzing apparatus comprises a motion database, a motion sensor unit and a microprocessor unit. The motion database stores at least one motion pattern. The motion sensor unit senses displacement variations of the portable device and outputs corresponding motion signals. The microprocessor unit receives the motion signals, compares the motion signals with the motion pattern of the motion database, and controls the output unit according to the comparison result.

The present invention also provides a motion analyzing apparatus for a portable device with an output unit. The motion analyzing apparatus comprises a music database, a motion sensor unit and a microprocessor unit. The music database stores at least one music data. The motion sensor unit senses displacement variations of the portable device and outputs corresponding motion signals. The microprocessor unit receives the motion signals, compares the motion signals with the music data, and outputs a control signal to the output unit according to the comparison result.

The present invention also provides a motion analyzing apparatus for a portable device with a display unit. The motion analyzing apparatus comprises a motion sensor unit and a microprocessor unit. The motion sensor unit senses displacement variations of the portable device and outputs corresponding motion signals. The microprocessor unit receives the motion signals to control a movement of an object displayed in the display unit corresponding to the motion signals.

The present invention also provides a motion analyzing method for a portable device with a database. The motion analyzing method comprises the following steps. Firstly, executes a motion program. Secondly, sensies displacement variations of the portable device to obtain motion signals. Thirdly, continually compares the motion signals and a motion pattern stored in the database and stores the comparison result in a storage unit. Finally, determines whether the sensing of the motion program is finished or not, if the answer is yes, analyzes the comparison result as a whole and outputs the analyze result.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of one embodiment of a motion analyzing apparatus of the present invention; and

FIG. 2 is a flow chart of a motion analyzing method of the present invention.

### DETAILED DESCRIPTION OF THE PREFERRED EMBODIMENTS

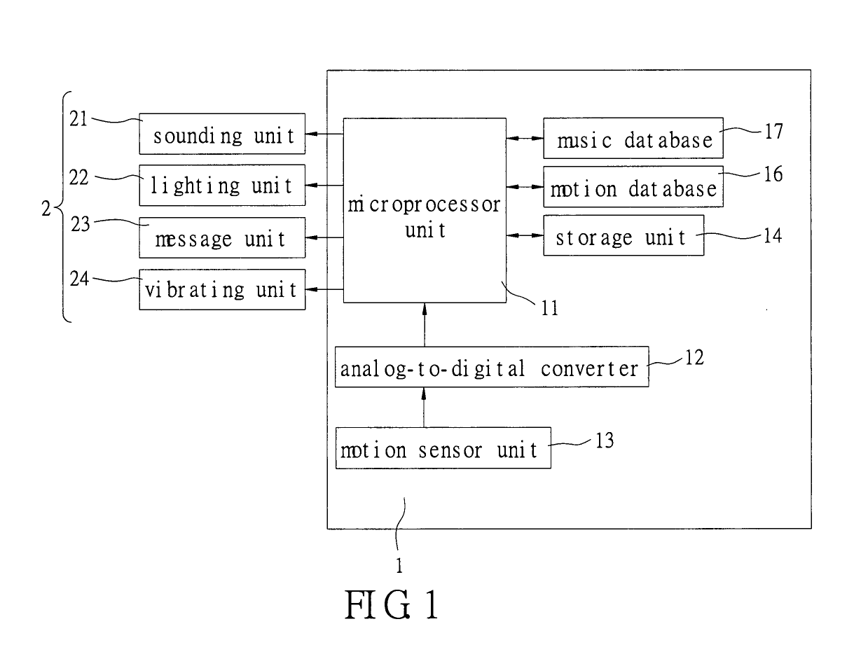

Please refer to FIG. 1, which shows a motion analyzing apparatus for a portable device. The present invention adds a motion sensor unit 13 in a portable device with an output unit 2. The motion sensor unit 13 can sense displacement variations of the portable device and output corresponding motion signals. Through this, the invention utilizes displacement variations of body motion to interact with the portable device and produces versatile entertainment that is extremely different from that of the prior art. Displacement variations of the portable device in the present invention mean a three-dimensional displacement.

For example, a conductor must wave his arms to conduct an orchestra to play music. So, the producer of such a program needs to collect a plurality of motion data making standard conductor motions as a reference and build a reference motion pattern that the user will possibly perform according to the above data. Therefore, when the user holds the portable device and waves his arms, it will produce a variety of predetermined effects if the user's motion is within a predetermined range to the reference motion pattern. The user needs to perform a correct conductor motion that is similar to the predetermined motion pattern to produce an effect (such as, the music rhythm, sound magnitude of musical instruments.)

The motion sensor unit 13 senses displacement variations of the portable device, such as direction, acceleration etc, to produce corresponding motion signals, such as voltage, vector signals, etc. The microprocessor unit 11 deals with the corresponding motion signals to obtain acceleration, vector, velocity and displacement of the motions.

This invention takes the conductor or music accompaniment as an example to explain the motion analyzing apparatus 1 of the first embodiment of the present invention. The motion analyzing apparatus 1 can be applied to a portable product with an output unit 2. The motion analyzing apparatus 1 comprises a motion database 16 that stores at least one reference motion pattern, a motion sensor unit 13 that senses displacement variations of the portable device and outputs corresponding motion signals, and a microprocessor unit 11 that receives the motion signals, compares the motion signals with the motion pattern of the motion database 16, and controls the output unit 2 according to the comparison result. The microprocessor unit 11 also connects to a storage unit 14 that is used for a buffer storage when the microprocessor unit 11 compares the data. Besides, the motion analyzing apparatus 1 further comprises a music database 17. The music database 17 stores at least one music data corresponding to the at least one motion pattern. For example, the music database 17 stores a first song that corresponds to the first conductor motion, a second song that corresponds to the second conductor motion, and so on. The output unit 2 (comprising at least one speaker) can output the music data that is stored in the music database 17 through the control of the microprocessor unit 11.

So, when the user selects ‘conductor’, such as by selecting a song or music, the portable device displays the waving instructions of this function, such as the waving method and beats per minute. The music data in the music database 17 comprises locations of music instruments, music, and beats in advance, for this conductor function. When the user starts the function, the portable device plays the music or/and beats according to the motion pattern and the body actions of the user.

When the user selects the function of musical accompaniment, such as by selecting a song or music, the portable device displays the instructions for this function. The music data in the music database 17 comprises the song and a plurality of accompanying music in advance for this function of musical accompaniment. When the user starts the function to play the selected song or music, the portable device plays the accompanying music according to the motion pattern of the user.

This invention takes physical exercise or a dancing machine as an example to explain the motion analyzing apparatus 1 of the second embodiment of the present invention. The motion analyzing apparatus 1 can be applied to a portable device with an output unit 2. The motion analyzing apparatus 1 comprises a music database 17 that stores at least one music data, such as dancing music or accompanying music, a motion sensor unit 13 that senses displacement variations of the portable device and outputs corresponding motion signals, and a microprocessor unit 11 that receives the motion signals, compares the motion signals with the music data, and outputs a control signal to the output unit 2 according to the comparison result. When the user selects ‘aerobic exercise, the portable device displays the instructions for this function, such as the exercising method and its benefits. When the user starts the function, the portable device records the motion signals of the user's motion and then obtains a comparison result by comparing the vibration frequencies of motion signals from the user's motions and the beats of the music data. After the function is finished, the microprocessor unit 11 analyzes the previous comparison result as a whole and outputs an analysis report or a score.

Moreover, the motion analyzing apparatus 1 further comprises a motion database 16. The motion database 16 stores at least one motion pattern that corresponds to the at least one music data. For example, the motion database 16 stores a first motion pattern that corresponds to the first dancing music, a second motion pattern that corresponds to the second dancing music, and so on. In other words, the microprocessor unit 11 uses one motion pattern that corresponds to the music data as a comparison base, and obtains a comparison result by comparing the motion pattern with motion signals. For example, the microprocessor unit 11 obtains a comparison result by comparing the motion signals with a first motion pattern that corresponds to the first dancing music.

So, when the user selects the function of ‘dancing machine’, such as selecting dance music, the portable device displays the dancing instructions for this function, such as the dancing method, beats per minute and the level of difficulty. The music database 17 stores the music and beats in advance. When the user starts the function, the portable device plays the selected dancing music, records the motion signals of the user's motion, and obtains a comparison result by comparing the vibration frequencies of motion signals of the user's motion with the beats per minute of the music data. After the function is finished, the microprocessor unit 11 analyzes the previous comparison result as a whole and outputs an analysis report or a score according to the matching ratio of the user's performance to the beats per minute and the accuracy of the user's movements. The portable device outputs music data from the music database 17 through an output unit 2 that comprises of at least one speaker.

In the motion analyzing apparatus 1 of the first and second embodiments, the output unit 2 is a sounding unit 21, a lighting unit 22, a vibrating unit 24, a message unit 23 or a combination thereof. The message unit 23 outputs a graph, a text, an image or a combination thereof. The storage unit 14 that is connected to the microprocessor unit 11 is a DRAM, flash memory or a combination thereof.

This invention takes a game of image deformation or rolling a ball into a hole as an example to explain the motion analyzing apparatus 1 of the third embodiment of the present invention. The motion analyzing apparatus 1 can be applied to a portable device with a display unit. The motion analyzing apparatus 1 comprises a motion sensor unit 13 that senses displacement variations of the portable device and outputs corresponding motion signals. A microprocessor unit 11 receives the motion signals and controls the movement of an object displayed in the display unit corresponding to the motion signals. Moreover, the motion analyzing apparatus 1 further comprises an output unit 2. The microprocessor unit 11 controls the output of the output unit 2 according to the motion signals. The output unit 2 is a sounding unit 21, a lighting unit 22, a vibrating unit 24 or a combination thereof.

Therefore, when the user selects a game of image deformation, the portable device displays an image, such as an image of a human's face, and produces a corresponding motion of the image according to the motion signal of the portable device produced by the user, and displays a deforming effect that is similar to a real object bumping the rim of the screen. Furthermore, it outputs a deforming sound through the output unit 2. The larger the waving motions of the user, the more the image is deformed, thereby producing a correspondingly amusing image.

When the user selects a game of rolling a ball into a hole, the portable device displays at least one fixed hole and a ball that's rolling direction can be controlled. The ball is moved according to the user's movement of the portable device. When the ball is rolled into a predetermined hole, the user scores points. At the same time, the portable device outputs a sound for getting a score through an output unit 2.

In the first and second embodiments of the present invention, the motion analyzing apparatus 1 further comprises an analog-to-digital converter 12. The analog-to-digital converter 12 electrically connects to the microprocessor unit 11 and the motion sensor unit 13. The analog-to-digital converter 12 converts an analog motion signal that is outputted from the motion sensor unit 13 into a digital motion signal, in order to be received and processed by the microprocessor unit 11. The motion sensor unit 13 is a three-dimensional sensing unit.

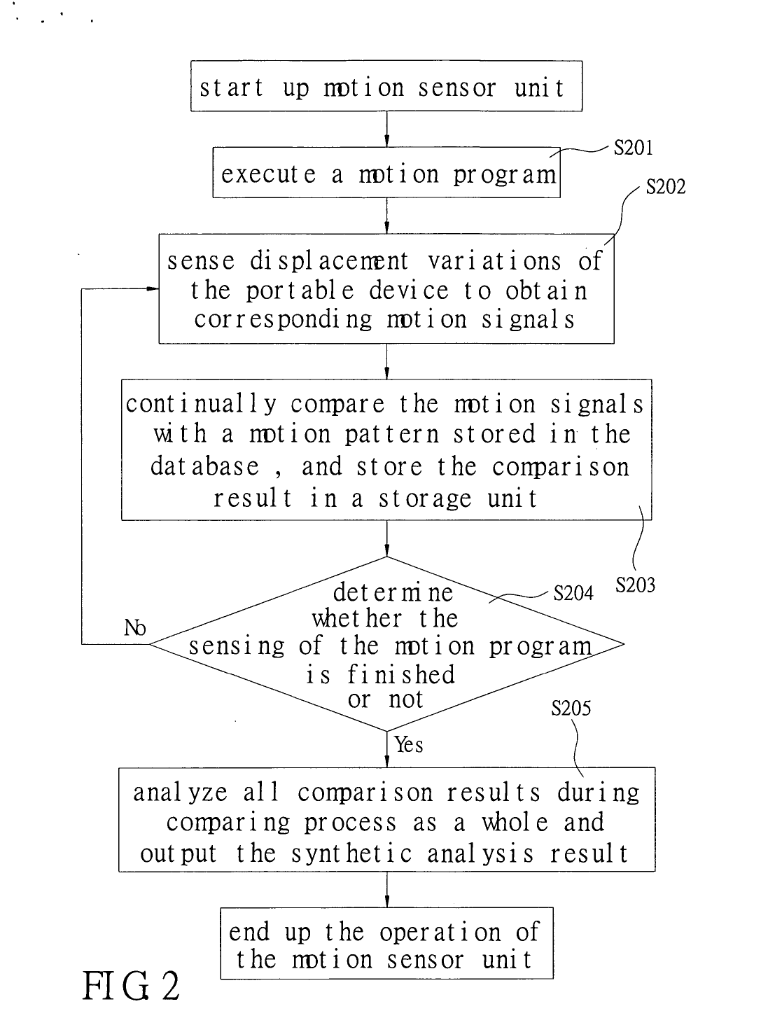

Please refer to FIG. 2, which shows a motion analyzing method that can be applied to a portable device with a database. The motion analyzing method comprises the following steps. Step 201 is to execute a motion program, such as a program for a dancing machine or a program for aerobic exercise. Step 202 is to sense displacement variations of the portable device to obtain corresponding motion signals. Step 203 is to continually compare the motion signals with a motion pattern stored in the database that corresponds to the motion program, and stores the comparison result in a storage unit. The database comprises at least one motion pattern and at least one music data. The motion pattern comprises the data of displacement variations in movement. The step of continually comparing the motion signals with a motion pattern is to determine whether the motion signals are within a predetermined range of the motion pattern that corresponds to the motion program. If being within the range, the comparison result is correct. If being without the range, the comparison result is error. Step 204 is to determine whether the sensing of the motion program is finished or not, if the answer is yes, the comparison results during the comparing process are analyzed as a whole and outputs the analysis result in step 205. The analysis result is a synthetic comparison analysis according to the all data comparison results during the comparing process. The analysis result is a score, an accuracy rate, a level or a combination thereof. For example, in the function of ‘dancing machine’, it shows the user's scores or level. The user can challenge himself or other people according to the scores or level. Moreover, the motion analyzing method further comprises an output unit. The output unit is controlled through a control signal that outputs according to the comparison result. The output unit is a sounding unit, a lighting unit, a vibrating unit, a message unit or a combination thereof. Taking the dancing machine as an example, it can play the selected dancing music and output a cheering sound that corresponds to the attained level after the game is finished.

This invention can effectively sense displacement variations in response to body motions of users and compares the results with a standard motion database. According to the comparison result, this invention outputs the result by any method to entertain user at anytime or at anyplace.

When the motion analyzing apparatus has other output effects, such as a beat sound, corresponding music, a score, an analysis report or accompanying sounds, etc, the motion analyzing apparatus can produce a lot of versatile activities and applications, such as physical exercise, a dancing machine, a conductor, musical accompaniment, games of deformation image and rolling a ball into a goal etc. As can be understood from the above descriptions, this invention offers abundant content and versatile entertainment features.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A motion analyzing apparatus for a portable device with an output unit, the motion analyzing apparatus comprising:
a motion database storing at least one motion pattern;
a motion sensor unit sensing displacement variations of the portable device and outputting corresponding motion signals; and
a microprocessor unit receiving the motion signals, comparing the least one motion signal with the motion patterns of the motion database, and controlling the output unit according to the comparison result.

2. The motion analyzing apparatus of claim 1, wherein the output unit is a sounding unit, a lighting unit, a vibrating unit, a message unit, or a combination thereof.

3. The motion analyzing apparatus of claim 1, further comprising a music database that stores at least one music data corresponding to the at least one motion pattern.

4. The motion analyzing apparatus of claim 1, further comprising an analog-to-digital converter that electrically connects to the microprocessor unit and the motion sensor unit.

5. A motion analyzing apparatus for a portable device with an output unit, the motion analyzing apparatus comprising:
a music database storing at least one music data;
a motion sensor unit sensing displacement variations of the portable device and outputting corresponding motion signals; and
a microprocessor unit, for receiving the motion signals, comparing the motion signals with the music data, and outputting a control signal to the output unit according to the comparison result.

6. The motion analyzing apparatus of claim 5, wherein the microprocessor unit compares vibration frequencies of the motion signal and the beats per minute of the music data to obtain a matched result.

7. The motion analyzing apparatus of claim 5, wherein the output unit is a sounding unit, a lighting unit, a vibrating unit, a message unit, or a combination thereof.

8. The motion analyzing apparatus of claim 5, further comprising a motion database that stores at least one motion pattern corresponding to the at least one music data.

9. The motion analyzing apparatus of claim 8, wherein the microprocessor unit compares the motion signal and at least one motion pattern that corresponds to the music data to obtain a comparison result.

10. A motion analyzing apparatus for a portable device with a display unit, the motion analyzing apparatus comprising:
a motion sensor unit sensing displacement variations of the portable device and outputting corresponding motion signals; and
a microprocessor unit, for receiving the motion signals to control a movement of an object displayed in the display unit corresponding to the motion signals.

11. The motion analyzing apparatus of claim 10, further comprising an output unit, wherein the microprocessor unit controls the output unit according to the motion signals.

12. The motion analyzing apparatus of claim 11, wherein the output unit is a sounding unit, a lighting unit, a vibrating unit, or a combination thereof.

13. A motion analyzing method for a portable device with a database, the motion analyzing method comprising following steps:
executing a motion program to sense displacement variations of the portable device to obtain motion signals;
comparing continually the motion signals and a motion pattern stored in the database that corresponds to the motion program, and storing the comparison result in a storage unit; and
determining whether the sensing of the motion program is finished or not, if the answer is yes, analyzing the comparison result as a whole and outputting the analysis result.

14. The motion analyzing method of claim 13, wherein the analyze result is a score, an accuracy rate or a level.

15. The motion analyzing method of claim 13, wherein the database comprises at least one motion pattern or at least one music data.

16. The motion analyzing method of claim 15, wherein the comparing step is to determine whether the motion signals are within a predetermined range of the motion pattern that corresponds to the motion program, if being within the range, the comparison result is correct, if being without the range, the comparison result is error.

17. The motion analyzing method of claim 16, wherein the motion pattern comprises data of displacement variations.

18. The motion analyzing method of claim 16, further comprising a step of outputting a control signal to control an output unit according to the comparison result.

19. The motion analyzing method of claim 18, wherein the output unit is a sounding unit, a lighting unit, a vibrating unit, a message unit, or a combination thereof.
